(19) United States
(12) Patent Application Publication
(10) Pub. No.: US 2004/0054656 A1
(43) Pub. Date: Mar. 18, 2004

(54) Techniques for balancing capacity utilization in a storage environment

(75) Inventors: Albert Leung, Los Altos, CA (US); Giovanni Paliska, Mountain View, CA (US); Bruce Greenblatt, San Jose, CA (US); Claudia Chandra, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA

(21) Appl. No.: 10/650,189

(22) Filed: Aug. 27, 2003

Related U.S. Application Data
(63) Continuation-in-part of application No. 10/232,875, filed on Aug. 30, 2002.
(60) Provisional application No. 60/407,587, filed on Aug. 30, 2002.
(60) Provisional application No. 60/407,450, filed on Aug. 30, 2002.
(60) Provisional application No. 60/358,915, filed on Feb. 21, 2002.
(60) Provisional application No. 60/316,764, filed on Aug. 31, 2001.

(51) Int. Cl. G06F 7/00

(52) U.S. Cl. 707/1

(57) ABSTRACT

Techniques for balancing capacity utilization in a storage environment. Embodiments of the present invention automatically determine when capacity utilization balancing is to be performed for a group of storage units in the storage environment. A source storage unit is determined from the group of storage units from which data is to be moved to balance capacity utilization. Utilized-capacity balancing is performed by moving data files from the source storage unit to one or more target storage units in the group of storage units. The storage units in a group may be assigned to one or more servers.

### CROSS-REFERENCES TO RELATED APPLICATIONS

The present application claims priority from and is a non-provisional application of the following provisional applications, the entire contents of which are herein incorporated by reference for all purposes:

(1) U.S. Provisional Application No. 60/407,587, filed Aug. 30, 2002 (Attorney Docket No. 21154-5US); and

(2) U.S. Provisional Application No. 60/407,450, filed Aug. 30, 2002 (Attorney Docket No. 21154-8US).

4 The present application also claims priority from and is a continuation-in-part (CIP) application of U.S. Non-Provisional Application No. 10/232,875, filed Aug. 30, 2002 (Attorney Docket No. 21154-000210US), which in turn is a non-provisional of U.S. Provisional Application No. 60/316,764, filed Aug. 31, 2001, (Attorney Docket No. 21154-000200US) and U.S. Provisional Application No. 60/358,915, filed Feb. 21, 2002 (Attorney Docket No. 21154-000400US). The entire contents of the aforementioned applications are herein incorporated by reference for all purposes.

The present application also incorporates by reference for all purposes the entire contents of U.S. Non-Provisional Application No. ___/______, filed concurrently with this application (Attorney Docket No. 21154-000810US).

### BACKGROUND OF THE INVENTION

The present invention relates generally to management of storage environments and more particularly to techniques for automatically balancing storage capacity utilization in a storage environment.

In a typical storage environment comprising multiple servers coupled to one or more storage units (either physical storage units or logical storage units such as volumes), an administrator administering the environment has to perform several tasks to ensure availability and efficient accessibility of data. In particular, an administrator has to ensure that there are no outages due to lack of availability of storage space on any server, especially servers running critical applications. The administrator thus has to monitor space utilization on the various servers. Presently, this is done either manually or using software tools that generate alarms/alerts when certain capacity thresholds associated with the storage units are reached or exceeded. In the manual approach, when an overcapacity condition is detected, the administrator has to manually move data from a storage unit experiencing the overcapacity condition to another storage unit that has sufficient space for storing the data without exceeding the capacity threshold for that server. This task can be very time consuming, especially in a storage environment comprising a large number of servers and storage units.

Additionally, a change in location of data from one location to another impacts existing applications, users, and consumers of the data. In order to minimize this impact, the administrator has to make adjustments to existing applications to update the data location information (e.g., the location of the database, mailbox, etc). The administrator also has to inform users about the new location of moved data. Accordingly, many of the conventional storage management operations and procedures are not transparent to data consumers.

More recently, several tools and applications are available that attempt to automate some of the manual functions performed by the administrator. For example, Hierarchical Storage Management (HSM) applications are used to migrate data among a hierarchy of storage devices. For example, files may be migrated from online storage to near-online storage, and from near-online storage to offline storage to manage storage utilization. When a file is migrated from its original storage location to a target storage location, a stub file or tag file is left in place of migrated file on the original storage location. The stub file occupies less storage space than the migrated file and may comprise metadata related to the migrated file. The stub file may also comprise information that can be used to determine the target location of the migrated file. A migrated file may be remigrated to another destination storage location.

In a HSM application, an administrator can set up rules/policies for migrating the files from expensive storage forms to less expensive forms of storage. While HSM applications eliminate some of the manual tasks that were previously performed by the administrator, the administrator still has to specifically identify the data (e.g., the file(s)) to be migrated, the storage unit from which to migrate the files (referred to as the “source storage unit”), and the storage unit to which the files are to be migrated (referred to as the “target storage unit”). As a result, the task of defining HSM policies can become quite complex and cumbersome in storage environments comprising a large number of storage units. The problem is further aggravated in storage environments in which storage units are continually being added or removed.

Another disadvantage of applications such as HSM is that the storage policies have to be defined on a per server basis. Accordingly, in a storage environment comprised of multiple servers, the administrator has to specify storage policies for each of the servers. This can also become quite cumbersome in storage environments comprising a large number of servers. Accordingly, even though storage management applications such as HSM applications reduce some of the manual tasks that were previously performed by administrators, they are still limited in their applicability and convenience.

### BRIEF SUMMARY OF THE INVENTION

Embodiments of the present invention provide techniques for balancing capacity utilization in a storage environment. Embodiments of the present invention automatically determine when utilized-capacity balancing is to be performed for a group of storage units in the storage environment. A source storage unit is determined from the group of storage units from which data is to be moved to balance capacity utilization. Utilized-capacity balancing is performed by moving data files from the source storage unit to one or more target storage units in the group of storage units. The storage units in a group may be assigned to one or more servers.

According to an embodiment of the present invention, techniques are provided for balancing capacity in a storage environment comprising storage units. In this embodiment: a condition indicating that capacity utilization balancing is to be performed for a plurality of storage units is detected, a first storage unit is identified from the plurality of storage units from which data is to be moved, a file stored on the first storage unit is identified to be moved, a storage unit is identified from the plurality of storage units for storing the file, the file is moved from the first storage unit to the storage unit identified for storing the file, and the identification of a file stored on the first storage unit to be moved, the identification of a storage unit from the plurality of storage units for storing the file, and the move of the file from the first storage unit to the storage unit identified for storing the file, is repeated until the condition is determined to be resolved.

According to another embodiment of the present invention, techniques are provided for balancing capacity in a storage environment comprising a plurality of storage units assigned to one or more servers. In this embodiment, a first group of storage units from the plurality of storage units is monitored. A first signal is received indicative of a condition. Responsive to the first signal, a first storage unit is determined from the first group of storage units from which data is to be moved. Data from the first storage unit is moved to one or more other storage units in the first group of storage units until the condition is resolved.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a storage environment that may incorporate an embodiment of the present invention;

FIG. 2 is a simplified block diagram of storage management system (SMS) according to an embodiment of the present invention;

FIG. 3 depicts three managed groups according to an embodiment of the present invention;

FIG. 4 is a simplified high-level flowchart depicting a method of balancing storage capacity utilization for a managed group of storage units according to an embodiment of the present invention;

FIG. 5 is a simplified flowchart depicting a method of selecting a file for a move operation according to an embodiment o the present invention;

FIG. 6 is a simplified flowchart depicting a method of selecting a file for a move operation according to an embodiment of the present invention wherein multiple placement rules are configured;

FIG. 7 is a simplified flowchart depicting a method of selecting a target volume from a managed group of volumes according to an embodiment of the present invention;

FIG. 8 is a simplified block diagram showing modules that may be used to implement an embodiment of the present invention; and

FIG. 9 depicts examples of placement rules according to an embodiment of the present invention.

### DETAILED DESCRIPTION OF THE INVENTION

In the following description, for the purposes of explanation, specific details are set forth in order to provide a thorough understanding of the invention. However, it will be apparent that the invention may be practiced without these specific details.

For purposes of this application, migration of a file involves moving the file (or a data portion of the file) from its original storage location on a source storage unit to a target storage unit. A stub or tag file may be stored on the source storage unit in place of the migrated file. The stub file occupies less storage space than the migrated file and generally comprises metadata related to the migrated file. The stub file may also comprise information that can be used to determine the target storage location of the migrated file. When a user or application accesses a stub on a source storage unit, a recall operation is performed. The recall transparently restores the migrated (or remigrated) file to its original storage location on the source storage unit for the user or application to access.

For purposes of this application, remigration of a file involves moving a previously migrated file from its present storage location to another storage location. The stub file information or information stored in a database corresponding to the remigrated file may be updated to reflect the storage location to which the file is remigrated.

For purposes of this application, unless specified otherwise, moving a file from a source storage unit to a target storage unit is intended to include migrating the file from the source storage unit to the target storage unit, or remigrating a file from the source storage unit to the target storage unit, or simply changing the location of a file from one storage location to another storage location. Movement of a file may have varying levels of impact on the end user. For example, in case of migration and remigration operations, the movement of a file is transparent to the end user. The use of techniques such as symbolic links in UNIX, Windows shortcuts may make the move somewhat transparent to the end user. Movement of a file may also be accomplished without leaving any stub, tag file, links, shortcuts, etc. This may impact the manner in which the users access the moved file.

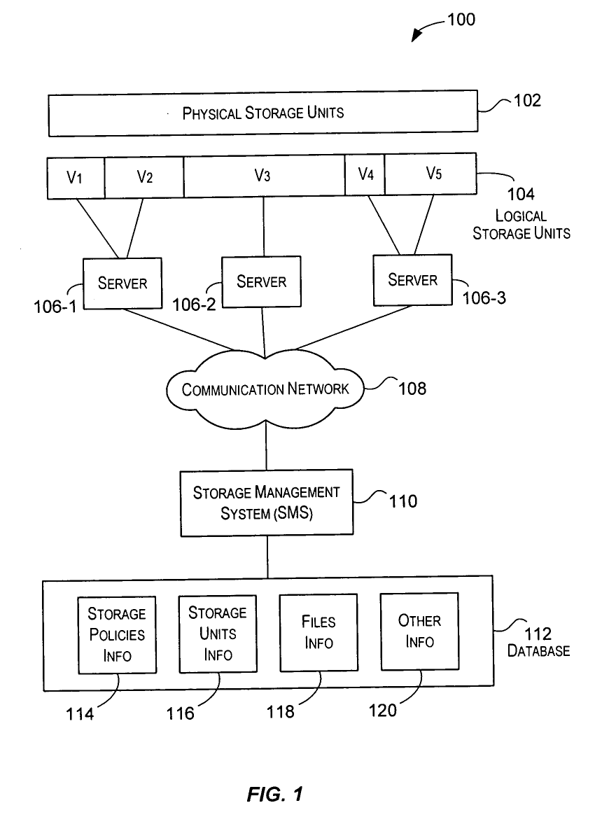

FIG. 1 is a simplified block diagram of a storage environment 100 that may incorporate an embodiment of the present invention. Storage environment 100 depicted in FIG. 1 is merely illustrative of an embodiment incorporating the present invention and does not limit the scope of the invention as recited in the claims. One of ordinary skill in the art would recognize other variations, modifications, and alternatives.

As depicted in FIG. 1, storage environment 100 comprises a plurality of physical storage devices 102 for storing data. Physical storage devices 102 may include disk drives, tapes, hard drives, optical disks, RAID storage structures, solid state storage devices, SAN storage devices, NAS storage devices, and other types of devices and storage media capable of storing data. The term “physical storage unit” is intended to refer to any physical device, system, etc. that is capable of storing information or data.

Physical storage units 102 may be organized into one or more logical storage units/devices 104 that provide a logical view of underlying disks provided by physical storage units 102. Each logical storage unit (e.g., a volume) is generally identifiable by a unique identifier (e.g., a number, name, etc.) that may be specified by the administrator. A single physical storage unit may be divided into several separately identifiable logical storage units. A single logical storage unit may span storage space provided by multiple physical storage units 102. A logical storage unit may reside on non-contiguous physical partitions. By using logical storage units, the physical storage units and the distribution of data across the physical storage units becomes transparent to servers and applications. For purposes of description and as depicted in FIG. 1, logical storage units 104 are considered to be in the form of volumes. However, other types of storage units including logical storage units and physical storage units are also within the scope of the present invention.

Storage environment 100 also comprises several servers 106. Servers 106 may be data processing systems that are configured to provide a service. Each server 106 may be assigned one or more volumes from logical storage units 104. For example, as depicted in FIG. 1, volumes V1 and V2 are assigned to server 106-1, volume V3 is assigned to server 106-2, and volumes V4 and V5 are assigned to server 106-3. A server 106 provides an access point for the one or more volumes assigned to that server. Servers 106 may be coupled to a communication network 108.

According to an embodiment of the present invention, a storage management system/server (SMS) 110 is coupled to server 106 via communication network 108. Communication network 108 provides a mechanism for allowing communication between SMS 110 and servers 106. Communication network 108 may be a local area network (LAN), a wide area network (WAN), a wireless network, an Intranet, the Internet, a private network, a public network, a switched network, or any other suitable communication network. Communication network 108 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), Fiber Channel protocols, protocols under development by industry standard organizations, vendor-specific protocols, customized protocols, and others.

SMS 110 is configured to provide storage management services for storage environment 100 according to an embodiment of the present invention. These management services include performing automated capacity management and data movement between the various storage units in the storage environment 100. The term “storage unit” is intended to refer to a physical storage unit (e.g., a disk) or a logical storage unit (e.g., a volume). According to an embodiment of the present invention, SMS 110 is configured to monitor and gather information related to the capacity usage of the storage units in the storage environment and to perform capacity management and data movement based upon the gathered information. SMS 110 may perform monitoring in the background to determine the instantaneous state of each of the storage units in the storage environment. SMS 110 may also monitor the file system in order to collect information about the files such as file size information, access time information, file type information, etc. The monitoring may also be performed using agents installed on the various servers 106 for monitoring the storage units assigned to the servers and the file system. The information collected by the agents may be forwarded to SMS 110 for processing according to the teachings of the present invention.

The information collected by SMS 110 may be stored in a memory or disk location accessible to SMS 110. For example, as depicted in FIG. 1, the information may be stored in a database 112 accessible to SMS 110. The information stored in database 112 may include information 114 related to storage policies and rules configured for the storage environment, information 116 related to the various monitored storage units, information 118 related to the files stored in the storage environment, and other types of information 120. Various formats may be used for storing the information. Database 112 provides a repository for storing the information and may be a relational database, directory services, etc. As described below, the stored information may be used to perform capacity utilization balancing according to an embodiment of the present invention.

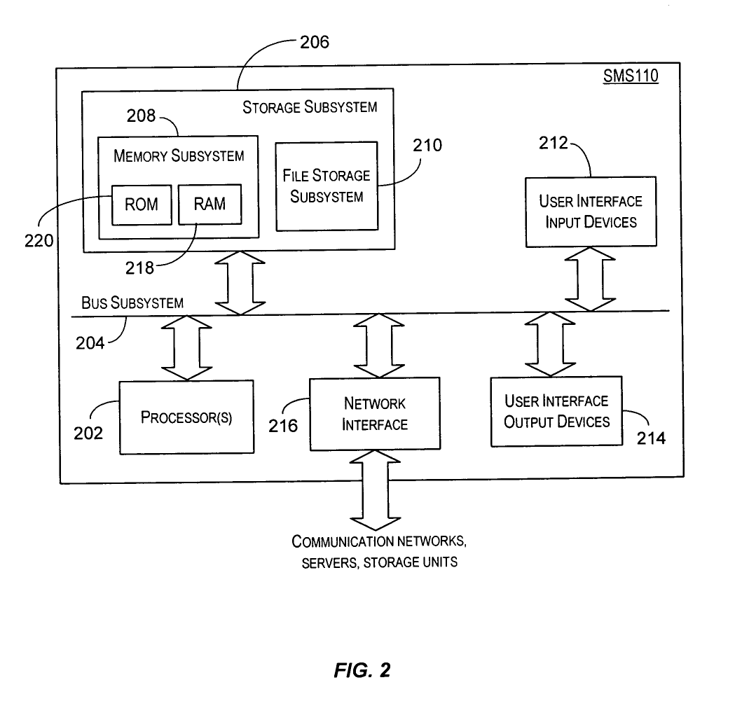

FIG. 2 is a simplified block diagram of SMS 110 according to an embodiment of the present invention. As shown in FIG. 2, SMS 110 includes a processor 202 that communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow a user, such as the administrator, to interact with SMS 110.

Network interface subsystem 216 provides an interface to other computer systems, networks, servers, and storage units. Network interface subsystem 216 serves as an interface for receiving data from other sources and for transmitting data to other sources from SMS 110. Embodiments of network interface subsystem 216 include an Ethernet card, a modem (telephone, satellite, cable, ISDN, etc.), (asynchronous) digital subscriber line (DSL) units, and the like.

User interface input devices 212 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to SMS 110.

User interface output devices 214 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from SMS 110.

Storage subsystem 206 may be configured to store the basic programming and data constructs that provide the functionality of the present invention. For example, according to an embodiment of the present invention, software code modules implementing the functionality of the present invention may be stored in storage subsystem 206. These software modules may be executed by processor(s) 202. Storage subsystem 206 may also provide a repository for storing data used in accordance with the present invention. For example, the information gathered by SMS 110 may be stored in storage subsystem 206. Storage subsystem 206 may also be used as a migration repository to store data that is moved from a storage unit. Storage subsystem 206 may also be used to store data that is moved from another storage unit. Storage subsystem 206 may comprise memory subsystem 208 and file/disk storage subsystem 210.

Memory subsystem 208 may include a number of memories including a main random access memory (RAM) 218 for storage of instructions and data during program execution and a read only memory (ROM) 220 in which fixed instructions are stored. File storage subsystem 210 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 204 provides a mechanism for letting the various components and subsystems of SMS 110 communicate with each other as intended. Although bus subsystem 204 is shown schematically as a single bus, alternative embodiments of the bus subsystem may utilize multiple busses.

SMS 110 can be of various types including a personal computer, a portable computer, a workstation, a network computer, a mainframe, a kiosk, or any other data processing system. Due to the ever-changing nature of computers and networks, the description of SMS 110 depicted in FIG. 2 is intended only as a specific example for purposes of illustrating the preferred embodiment of the computer system. Many other configurations having more or fewer components than the system depicted in FIG. 2 are possible.

Embodiments of the present invention perform capacity utilization balancing (also referred to as utilized-capacity balancing) between multiple storage units. Utilized-capacity balancing generally involves moving one or more files from a storage unit (referred to as the “source storage unit”) to one or more other storage units (referred to as “target storage units”). As described above in the “Background” section, in conventional HSM-type applications, in order to perform data movement, the administrator has to explicitly specify the file(s) to be moved, the source storage unit, and the target storage unit to which the files are to be moved. According to embodiments of the present invention, the administrator does not have to explicitly specify the file to be moved, the source storage unit, or the target storage unit. The administrator may only specify a group of storage units to be managed (referred to as the “managed group”). For a specified group of storage units to be managed, embodiments of the present invention automatically determine when capacity utilization balancing is to be performed. Embodiments of the present invention also automatically identify the source storage unit, the file(s) to be moved, and the one or more target storage units to which the selected file(s) are to be moved.

According to an embodiment of the present invention, each managed group may include one or more storage units. The storage units in a managed group may be assigned or coupled to one server or to multiple servers. A particular storage unit can be a part of multiple managed groups. Multiple managed groups may be defined for a storage environment.

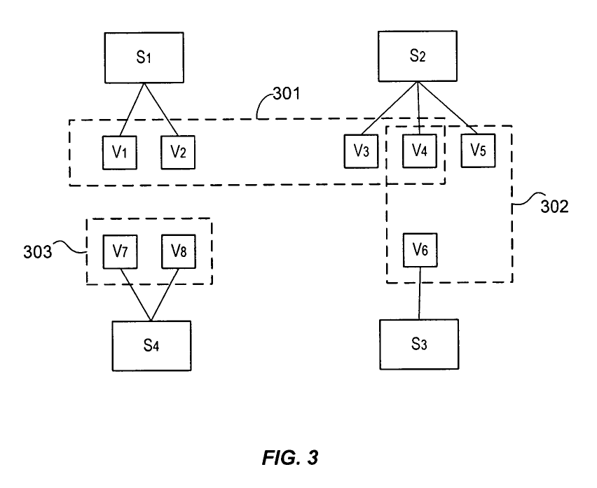

FIG. 3 depicts three managed groups according to an embodiment of the present invention. The first managed group 301 includes four volumes, namely, V1, V2, V3, and V4. Volumes V1 and V2 are assigned to server S1, and volumes V3 and V4 are assigned to server S2. Accordingly, managed group 301 comprises volumes assigned to multiple servers. The second managed group 302 includes three volumes, namely, V4 and V5 assigned to server S2, and V6 assigned to server S3. Volume V4 is part of managed groups 301 and 302. Managed group 303 includes volumes V7 and V8 assigned to server S4. Various other managed groups may also be specified.

Various techniques are provided for specifying managed groups. According to one technique, embodiments of the present invention automatically form managed groups based upon the servers or hosts that manage the storage units. In this embodiment, all storage units that are allocated to a server or host and/or volumes allocated to a NAS host may be grouped into one managed group. For example, all volumes coupled to a server or host are grouped into one managed volume. The managed group may also include SAN volumes that are managed by the server or host.

According to another technique, an administrator may define volume groups by selecting storage units to be included in a group. For example, a user interface may be displayed on SMS 100 that displays a list of storage units in the storage environment that are available for selection. A user may then form managed groups by selecting one or more of the displayed storage units.

According to another technique, managed groups may be automatically formed based upon criteria specified by the administrator. According to this technique, an administrator may define criteria for a managed group and a storage unit is included in a managed group if it satisfies the criteria specified for that managed group. The criteria generally relate to attributes of the storage units. For example, criteria for specifying a group of volumes may include a criterion related to volume capacity, a criterion related to cost of storage, a criterion related to the manufacturer of the storage device, a criterion related to device type, a criterion related to the performance characteristics of the storage device, and the like.

The administrator may specify the volume capacity criterion by specifying an upper bound and/or a lower bound. For example, in order to configure a “large” volumes managed group, the administrator may set a lower bound condition of 500 GB and an upper bound condition of 2 TB. Only those volumes that fall within the range identified by the lower bound and the upper bound are included in the “large” volumes managed group. The administrator may set up a managed volume group for “expensive” volumes by specifying a lower bound of $2 per GB and an upper bound of $5 per GB. Only those volumes that fall within the specified cost range are then included in the “expensive” volumes managed group. The administrator may set up a managed group by specifying that storage units manufactured by a particular manufacturer or storage units having a particular model number are to be included in the managed group. The administrator may also specify a device type for forming a managed group. The device type may be selectable from a list of device types including SCSI, Fibre Channel, IDE, NAS, etc. A storage unit is then included in a managed group if its device type matches the administrator-specified device type(s).

Device-based groups may also be configured in which all volumes allocated from the same device, regardless of whether those volumes are assigned to a single server or multiple servers in a network, are grouped into one group.

Accordingly, various criteria may be specified for forming managed groups. A storage unit is included in a particular managed group if the storage unit matches the criteria specified for that particular managed group. The administrator may also form managed groups based upon other managed groups. For example, the administrator may form a group which includes storage units in the “large” volumes managed group and the “expensive” volumes managed group.

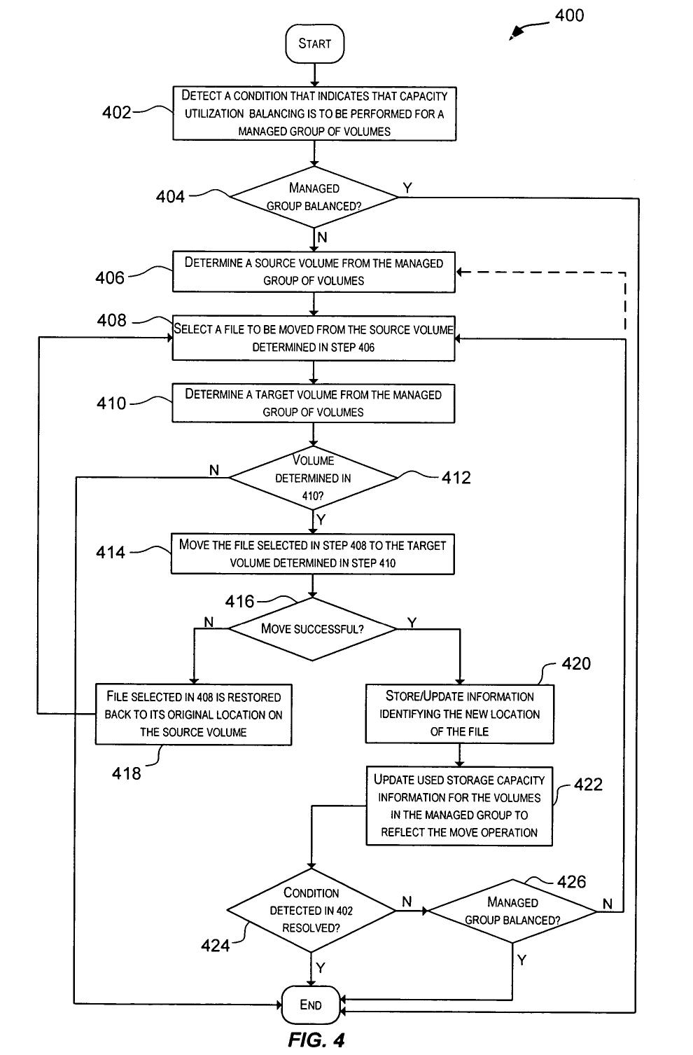

For each managed group, embodiments of the present invention automatically perform utilized-capacity balancing for the storage units in the managed group. FIG. 4 is a simplified high-level flowchart 400 depicting a method of balancing storage capacity utilization for a managed group of storage units according to an embodiment of the present invention. The method depicted in FIG. 4 may be performed by software modules executed by a processor, hardware modules, or combinations thereof According to an embodiment of the present invention, the processing is performed by a policy management engine (PME) executing on SMS 110. Flowchart 400 depicted in FIG. 4 is merely illustrative of an embodiment of the present invention and is not intended to limit the scope of the present invention. Other variations, modifications, and alternatives are also within the scope of the present invention. For sake of description, the processing depicted in FIG. 4 assumes that the storage units are in the form of volumes. It should be apparent that the processing can also be applied to other types of storage units.

As depicted in FIG. 4, processing is initiated when a condition is detected that indicates that capacity utilization balancing is to be performed for a managed group of volumes (step 402). The condition may be detected under various circumstances. For example, the condition detected in step 402 may represent an over-capacity condition or alert for a volume included in the managed set of volumes. According to an embodiment of the present invention, an over-capacity condition occurs when the used storage capacity of a volume in the managed set of volumes reaches or exceeds a capacity threshold specified for the managed set of volumes or specified for that particular volume (or when the available storage capacity of a volume in the managed set of volumes falls below a capacity threshold specified for the managed set of volumes or for that particular volume).

As described above, embodiments of the present invention continuously or periodically monitor and gather information on the memory usage of the storage units in a storage environment. The gathered information may be used to detect the over-capacity condition. The over-capacity condition may also be detected using other techniques known to those skilled in the art.

As part of step 402, the extent of the overcapacity may also be determined. This may be determined by calculating the difference between the used storage capacity of the volume experiencing the overcapacity condition and the threshold capacity specified for that managed group of volumes or for the particular volume (e.g., extent of overcapacity=(used storage capacity of volume)−(capacity threshold for the volume)).

The condition in step 402 may also be triggered when the difference in used capacity of any two volumes in the managed group of volumes usage exceeds a user-configurable threshold value, for example, the difference in used capacity of the least full volume and the most full volume in the managed groups of volumes exceeds the threshold. The user-configurable threshold will be referred to as the “band threshold value”. The band threshold value allows the administrator to prevent the underutilization of a volume and the over-utilization of another volume in the managed group of volumes.

The condition in step 402 may also be triggered by a user such as the storage system administrator. The condition may also be triggered by another application or system. For example, the condition may be triggered every night by a cron job in a UNIX environment, a schedules task in Windows, etc.

A check is then made to see if the managed group of volumes is balanced (step 404). A user-configurable parameter referred to as the “balance guard parameter” is used to determine if the volumes in the managed group of volumes are balanced. According to an embodiment of the present invention, a sliding scale is used to determine if the managed group of volumes is balanced. The managed group of volumes is considered balanced if the difference in used storage capacity of the most full volume in the managed group of volumes and the used storage capacity of the least full volume in the managed group of volumes is within the balance guard parameter. For example, consider a scenario where the used capacity threshold for a managed group of volumes is set to 80% and the balance guard parameter is set to 12%. Further, consider that the used storage capacity of the most full volume in the managed group of volumes is 82% (i.e., the volume is experiencing an overcapacity condition) and the used storage capacity of the least full volume in the managed group of volumes is 71%. In this scenario, even though a managed volume is experiencing over-capacity, the managed group of volumes is considered balanced since (82−71)<12.

Accordingly, in step 404, the difference between the used storage capacity of the fullest volume in the managed group of volumes and the used storage capacity of the least full volume in the managed group of volumes is determined. If the difference is less than or equal to the balance guard parameter then the managed group of volumes is considered to be balanced (even though an individual volume may be experiencing an over-capacity condition). If the capacity utilization of the managed group is considered balanced, then the capacity utilization balancing is terminated for the condition detected in step 402. Information may optionally be output indicating the reasons why the process was halted. The managed groups of volumes continue to be monitored for the next condition that triggers the processing depicted in FIG. 4.

If the managed groups of volumes is determined to be not balanced, then a volume, from the managed group of volumes, from which data is to be moved (i.e., the source volume) is determined (step 406). The identity of the source volume depends on the type of condition detected in step 402. For example, if an overcapacity condition was detected in step 402, then the volume that is experiencing the overcapacity condition is determined to be the source volume in step 406. If the condition in step 402 was triggered because the difference in used capacity of any two volumes (e.g., the least full volume and the most full volume) in the managed group of volumes usage exceeds the band threshold value, then the fullest volume is determined to be the source volume in step 406. Other techniques may also be used to determine the source volume from the managed group of volumes.

A file stored on the source volume determined in step 406 and is then selected to be moved to another volume in the managed group of volumes (step 408). Various techniques may be used for selecting the file to be moved from the source volume. According to one technique, the largest file stored on the source volume is selected. According to another technique, the least recently accessed file may be selected to be moved. Other file attributes such as age of the file, type of the file, etc. may also be used to select a file to be moved.

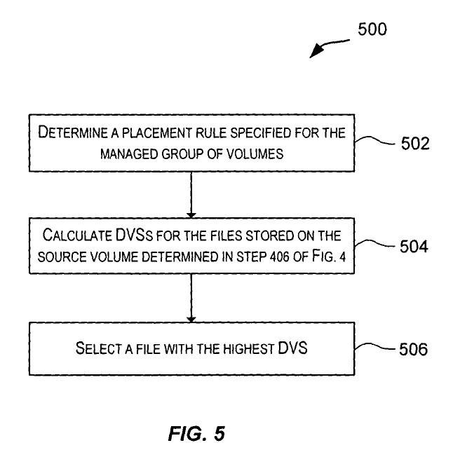

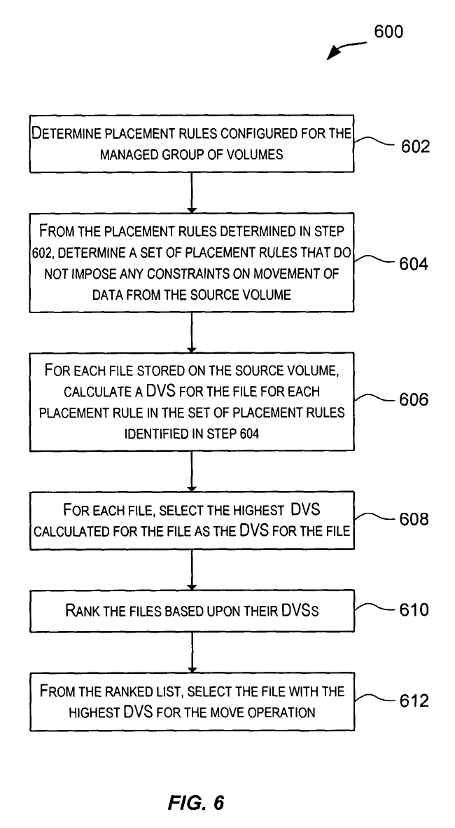

According to an embodiment of the present invention, the techniques described in U.S. patent application Ser. No. 10/232,875 filed Aug. 30, 2002 (Attorney Docket No. 21154-000210US), and described below, may be used to select the file to be moved from the source volume. According to these techniques, a data value score (DVS) score is generated for the files stored on the source volume, and the file with the highest DVS is selected for the move operation. Further description related to these techniques is discussed below with reference to FIGS. 5 and 6.

A volume (referred to as the target volume) from the managed group of volumes to which the file selected in step 408 is to be moved is then determined (step 410). Various techniques may be used for selecting the target volume. According to one embodiment, the least full volume from the managed group of volumes is selected as the target. According to another embodiment of the present invention, the administrator may specify criteria for selecting a target, and a volume that satisfies the criteria is selected as the target volume. According to yet another embodiment, techniques described in U.S. patent application Ser. No. 10/232,875 filed Aug. 30, 2002 (Attorney Docket No. 21154-000210US), and described below, may be used to select a target volume for storing the file selected in step 408. In this embodiment, a storage value score (SVS or RSVS) is generated for the various volumes in the managed group of volumes and the volume with the highest SVS is selected as the target volume. Further details related to these techniques are given below.

A check is then made to determine if a volume was selected in step 410 (step 412). If no volume could be determined in step 410, the processing depicted in FIG. 4 is terminated for the condition detected in step 402. After processing terminates, the managed groups of volumes continue to be monitored for the next condition that triggers the processing depicted in FIG. 4. The non selection of a volume in step 410 may indicate that the selected file cannot be moved to another volume within the managed group of volumes without triggering an overcapacity condition (or some other condition) on the other volumes or some other alert condition. It may also indicate that the other volumes are not available to store the file.

If a volume is selected in step 410, then the file selected in step 408 is moved from the source volume to the target volume selected in step 410 (step 414). A check is then made to determine if the move operation was successful (step 416). If the move operation was unsuccessful, then the file selected in step 408 is restored back to it original location on the source volume (step 418). Processing then continues with step 408. If the move operation was successful, then information identifying the new location of the selected file on the target volume is stored and/or updated (step 420). For example, if the move involves a migrate operation, then a stub file may be created for the migrated file and updated to store information that can be used to locate the new location of the file on the target volume. If the move involves a remigrate operation, then the stub file for the remigrated file may be updated to store information that can be used to locate the new location of the file. Other information such as symbolic links in UNIX, shortcuts in Windows, etc. may also be left in the original storage location. In certain situations, the administrator may need to inform end users of the move operation. The information may also be stored or updated in a storage location (e.g., a database) accessible to SMS 110.

The used storage capacity usage information for the volumes in the managed group of volumes is then updated to reflect the file move (step 422). A check is then made to see if the condition detected in step 402 has been resolved (step 424). For example, if the condition in step 402 was an overcapacity condition, a check is made in step 424 to determine if the overcapacity condition for the managed group of volumes has been resolved. If the condition in step 402 was triggered because the difference in used capacity of the least full volume and the fullest volume in the managed groups of volumes exceeded the band threshold value, then a check is made in step 424 if the difference is within the band threshold value. If it is determined in step 424 that the condition has been resolved, then processing terminates for the condition detected in step 402. Volumes in the managed group continue to be monitored for the next condition that triggers the processing depicted in FIG. 4.

If it is determined in step 424 that the condition has not been resolved, then a check is made to determine if the managed group of volumes is balanced (step 426). The processing performed in step 426 is similar to the processing performed in step 404. If it is determined that the managed volumes are balanced, then processing is terminated for the condition detected in step 402. If it is determined that the managed volumes are not balanced, then processing continues with step 408 wherein another file from the source volume is selected to be moved. Alternatively, processing may continue with step 406 to select another source volume. The steps, as described above, are then repeated.

It should be noted that when a target volume is to be selected in step 410 for moving the selected file, different volumes from the managed group of volumes may be selected during successive passes of the flowchart based upon the conditions associated with the volumes. Embodiments of the present invention thus provide the ability to automatically and dynamically select a volume for moving data based upon the dynamic conditions associated with the managed volumes.

FIG. 5 is a simplified flowchart 500 depicting a method of selecting a file for a move operation according to an embodiment of the present invention. In one embodiment, the processing depicted in FIG. 5 is performed in step 408 of the flowchart depicted in FIG. 4. The processing in FIG. 5 may be performed by software modules executed by a processor, hardware modules, or combinations thereof. According to an embodiment of the present invention, the processing is performed by a policy management engine (PME) executing on SMS 110. Flowchart 500 depicted in FIG. 5 is merely illustrative of an embodiment of the present invention and is not intended to limit the scope of the present invention. Other variations, modifications, and alternatives are also within the scope of the present invention.

As depicted in FIG. 5, a placement rule specified for the managed group of volumes is determined (step 502). Examples of placement rules according to an embodiment of the present invention are provided in U.S. patent application Ser. No. 10/232,875 filed Aug. 30, 2002 (Attorney Docket No. 21154-000210US), and described below. For sake of simplicity of description, it is assumed for the processing depicted in FIG. 5 that a single placement rule is defined for the managed group of volumes and that placement rule does not restrict the data from being moved from the local volume.

Given the placement rule determined in step 502, data value scores (DVSs) are then calculated for the files stored on the source volume selected in step 406 in FIG. 4 (step 504). The file with the highest DVS is then selected for the move operation (step 506). According to an embodiment of the present invention, the processing depicted in FIG. 5 is performed the first time that a file is to be selected. During this first pass, the files may be ranked based upon their DVSs calculated in step 506. The ranked list of files is then available for subsequent selections of the files during subsequent passes of the flowchart depicted in FIG. 4. The highest ranked and previously unselected file is then selected during each pass.

According to an embodiment of the present invention, files that contain migrated data are selected for the move operation before files that contain original data (i.e., files that have not been migrated). A migrated file comprises data that has been migrated or remigrated from its original storage location by applications such as HSM applications. Generally, a stub or tag file is left in the original storage location of the migrated file identifying the migrated location of the file. An original file represents a file that has not been migrated or remigrated.

Thus, according to an embodiment of the present invention, migrated files are moved before original files. In this embodiment, in step 506, two separate ranked lists are created based upon the DVSs associated with the files (or based upon file size): one list comprising migrated files ranked based upon their DVSs, and the other comprising original files ranked based upon their DVSs. When a file is to be selected for a move operation in order to balance capacity utilization between volumes in the managed group of volumes, files from the ranked migrated files list are selected before selection of files from the ranked original files list (i.e., files from the original files list are not selected until the files on the migrated files list have been selected and moved).

According to an embodiment of the present invention, file groups may be configured for the storage environment. A file is included in a file group if the file satisfies criteria specified for the file group. The file group criteria may be specified by the administrator. For example, an administrator may create file groups based upon a business value associated with the files. The administrator may group files that are deemed important or critical for the business into one file group (a “more important” file group) and the other files may be grouped into a second group (a “less important” file group). Other criteria may also be used for defining file groups including file size, file type, file owner or group of owners, last modified time of the file, last access time of a file, etc. The file groups may be created by the administrator or automatically by a storage policy engine. The file groups may also be prioritized relative to each other depending upon the files included in the file groups. Based upon the priorities associated with the file groups, files from a certain file group may be selected for the move operation in step 506 before files from another group. For example, the move operation may be configured such that files from the “less important” file group are moved before files from the “more important” file group. Accordingly, in step 506, files from the “less important” file group are selected for the move operation before files from the “more important” file group. Within a particular file group, the DVSs associated with the files may determine the order in which the files are selected for the move operation.

In FIG. 5 it was assumed that only one placement rule was configured for a managed group of volumes. However, in other embodiments, multiple placement rules may be configured for a managed group of volumes or for the storage environment. FIG. 6 is a simplified flowchart 600 depicting a method of selecting a file for a move operation according to an embodiment of the present invention wherein multiple placement rules are configured. In one embodiment, the processing depicted in FIG. 6 is performed in step 408 of the flowchart depicted in FIG. 4. The processing in FIG. 6 may be performed by software modules executed by a processor, hardware modules, or combinations thereof. According to an embodiment of the present invention, the processing is performed by a policy management engine (PME) executing on SMS 10. Flowchart 600 depicted in FIG. 6 is merely illustrative of an embodiment of the present invention and is not intended to limit the scope of the present invention. Other variations, modifications, and alternatives are also within the scope of the present invention.

As depicted in FIG. 6, the multiple placement rules configured for the managed group of volumes (or configured for the storage environment) are determined (step 602). Examples of placement rules according to an embodiment of the present invention are provided in U.S. patent application Ser. No. 10/232,875 filed Aug. 30, 2002 (Attorney Docket No. 21154-000210US), and described below.

A set of placement rules that do not impose any constraints on moving data from a source volume are then determined from the rules determined in step 602 (step 604). For each file stored on the source volume, a DVS is calculated for the file for each placement rule in the set of placement rules identified in step 604 (step 606). For each file, the highest DVS calculated for the file, from the DVSs generated for the file in step 604, is then selected as the DVS for that file (step 608). In this manner, a DVS is associated with each file. The files are then ranked based upon their DVSs (step 610). From the ranked list, the file with the highest DVS is then selected for the move operation in order to balance capacity utilization between volumes in the managed group of volumes (step 612).

According to an embodiment of the present invention, the processing depicted in FIG. 6 is performed the first time that a file is to be selected during the first pass of the flowchart depicted in FIG. 4. During this first pass, the files may be ranked based upon their DVSs in step 610. The ranked list of files is then available for subsequent selections of the files during subsequent passes of the flowchart depicted in FIG. 4. The highest ranked and previously unselected file is then selected during each subsequent pass.

According to an embodiment of the present invention, files that contain migrated data are selected for the move operation before files that contain original data (i.e., files that have not been migrated). A migrated file comprises data that has been migrated (or remigrated) from its original storage location by applications such as HSM applications. Generally, a stub or tag file is left in the original storage location of the migrated file identifying the migrated location of the file. An original file represents a file that has not been migrated or remigrated.

Thus, according to an embodiment of the present invention, migrated files are moved before original files. In this embodiment, in step 612, two separate ranked lists are created based upon the DVS scores associated with the files: one list comprising migrated files, and the other comprising original files. When a file is to be selected for a move operation in order to balance capacity utilization between a managed group of volumes, files from the ranked migrated files list are selected before selection of files from the ranked original files list (i.e., files from the original files list are not selected until the files on the migrated files list have been selected and moved).

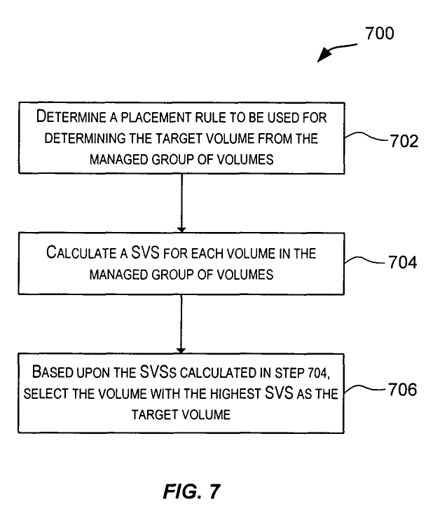

FIG. 7 is a simplified flowchart 700 depicting a method of selecting a target volume from a managed group of volumes according to an embodiment of the present invention. In one embodiment, the processing depicted in FIG. 7 is performed in step 410 of the flowchart depicted in FIG. 4. The processing in FIG. 7 may be performed by software modules executed by a processor, hardware modules, or combinations thereof. According to an embodiment of the present invention, the processing is performed by a policy management engine (PME) executing on SMS 110. Flowchart 700 depicted in FIG. 7 is merely illustrative of an embodiment of the present invention and is not intended to limit the scope of the present invention. Other variations, modifications, and alternatives are also within the scope of the present invention.

As depicted in FIG. 7, a placement rule to be used for determining a target volume from the managed group of target volumes is determined (step 702). In an embodiment where a single placement rule is configured for the managed group of volumes, that single placement rule is selected in step 702. In embodiments where multiple placement rules are configured for the managed group of volumes (or for the storage environment), the placement rule selected in step 702 corresponds to the placement rule that generated the DVS associated with the selected file.

Using the placement rule determined in step 702, a storage value score (SVS) (or “relative storage value score” RSVS) is generated for each volume in the managed group of volumes (step 704). The SVS for a volume indicates the degree of suitability of storing the selected file on that volume. The SVS may not be calculated for the source volume in step 704. Various techniques may be used for calculating the SVSs. According to an embodiment of the present invention, the SVSs may be calculated using techniques described in U.S. patent application Ser. No. 10/232,875 filed Aug. 30, 2002 (Attorney Docket No. 21154-000210US), and described below. The SVSs are referred to as relative storage value scores (RSVSs) in U.S. patent application Ser. No. 10/232,875. The volume with the highest SVS score is then selected as the target volume (step 706).

In the flowchart depicted in FIG. 4, the SVSs are recalculated every time that a target volume is to be determined (in step 410) for storing the selected file as the SVS for a particular volume may change based upon the conditions associated with the volume. Accordingly, different volumes from the managed group of volumes may be selected during successive passes of the flowchart depicted in FIG. 7. Embodiments of the present invention thus provide the ability to automatically and dynamically select a volume for moving data based upon the dynamic conditions associated with the managed volumes.

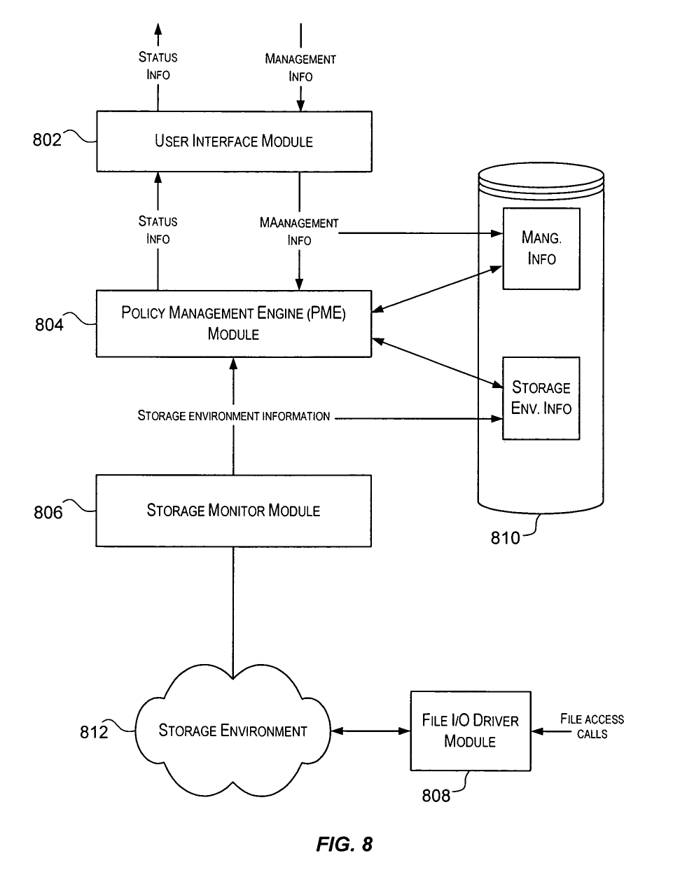

FIG. 8 is a simplified block diagram showing modules that may be used to implement an embodiment of the present invention. The modules depicted in FIG. 8 may be implemented in software, hardware, or combinations thereof. As shown in FIG. 8, the modules include a user interface module 802, a policy management engine (PME) module 804, a storage monitor module 806, and a file I/O driver module 808. It should be understood that the modules depicted in FIG. 8 are merely illustrative of an embodiment of the present invention and are not meant to limit the scope of the invention. One of ordinary skill in the art would recognize other variations, modifications, and alternatives.

User interface module 802 allows a user (e.g., an administrator) to interact with the storage management system. An administrator may provide rules/policy information for managing storage environment 812, information identifying the managed groups of storage units, thresholds information, selection criteria, etc., via user interface module 802. The information provided by the user may be stored in memory and/or disk storage 810. Information related to storage environment 812 may be output to the user via user interface module 802. The information related to the storage environment that is output may include status information about the capacity of the various storage units in the storage environment, the status of utilized-capacity balancing operations, error conditions, and other information related to the storage system. User interface module 802 may also provide interfaces that allow a user to define the managed groups of storage units using one or more techniques described above.

User interface module 802 may be implemented in various forms. For example, user interface 802 may be in the form of a browser-based user interface, a graphical user interface, text-based command line interface, or any other application that allows a user to specify information for managing a storage environment and that enables a user to receive feedback, statistics, reports, status, and other information related to the storage environment.

The information received via user interface module 802 may be stored in a memory and/or disk storage 810 and/or forwarded to PME module 804. The information may be stored in the form of configuration files, Windows Registry, a directory service (e.g., Microsoft Active Directory, Novell eDirectory, OpenLDAP, relational database, etc), and the like. PME module 804 is also configured to read the information from memory and/or disk storage 810.

Policy management module 804 is configured to perform the processing to balance storage capacity between managed storage units according to an embodiment of the present invention. Policy management module 804 uses information received from user interface module 802 (or stored in memory and/or disk storage 810) and information related to storage environment 812 received from storage monitor module 806 to automatically perform the 10 utilized-capacity balancing task. According to an embodiment of the present invention, PME module 804 is configured to perform the processing depicted in FIGS. 4, 5, 6, and 7.

Storage monitor module 806 is configured to monitor storage environment 812. The monitoring may be done on a continuous basis or on a periodic basis. As described above, the monitoring may include monitoring attributes of the storage units such as usage information, capacity utilization, types of storage devices, etc. Monitoring also include monitoring attributes of the files in storage environment 812 such as file size information, file access time information, file type information, etc. The monitoring may also be performed using agents installed on the various servers coupled to the storage units or may be done remotely using agents running on other systems. The information gathered from the monitoring activities may be stored in memory and/or disk storage 810 or forwarded to PME module 804.

Various formats may used for storing the information in memory and/or disk storage 810. For example, the storage capacity usage for a storage unit may be expressed as a percentage of the total storage capacity of the storage unit. For example, if the total storage capacity of a storage unit is 100 Mbytes, and if 40 Mbytes are free for storage (i.e., 60 Mbytes are already used), then the used storage capacity of the storage unit may be expressed as 60% (or alternatively, 40% available capacity). The value may also be expressed as the amount of free storage capacity (e.g., in MB, GB, etc.) or used storage.

PME module 806 may use the information gathered from the monitoring to detect presence of conditions that trigger a utilized-capacity balancing operation. For example, PME module 806 may use the gathered information to determine if a storage unit in storage environment 812 is experiencing an overcapacity condition, if the difference in used capacity of any two volumes (e.g., the least full volume and the most full volume) in a managed group of volumes usage exceeds the “band threshold value”, etc.

File I/O driver module 808 is configured to intercept file system calls received from consumers of data stored by storage environment 812. For example, file I/O driver module 808 is configured to intercept any file open call (which can take different forms in different operating systems) received from an application, user, or any data consumer. When file I/O driver module 808 determines that a requested file has been migrated from its original location to a different location, it may suspend the file open call and perform the following operations: (1) File I/O driver 808 may determine the actual location of the requested data file in storage environment 812. This can be done by looking up from the file header or stub file that is stored in the original location. Alternatively, if the file location information is stored in a persistent storage location (e.g., a database managed by PME module 804), file I/O driver 808 may determine the actual remote location of the file from that persistent location; (2) File I/O driver 808 may then restore the file content from the remote storage unit location; (3) File I/O driver 808 then resumes the file open call so that the application can resume with the restored data. File I/O driver 808 may also create stub or tag files.

Techniques for Generating DVSs and SVSs using Placement Rules

As described above, an embodiment of the present invention can automatically determine files to be moved and target storage units for storing the files using DVSs and SVSs calculated using one or more placement rules. According to an embodiment of the present invention, each placement rule comprises: (1) data-related criteria and (2) device-related criteria. The data-related criteria comprises criteria associated with the data to be stored and is used to select the file to move. According to an embodiment, the data-related criteria comprises (a) data usage criteria information, and (b) file selection criteria information.

The device-related criteria comprises criteria related to storage units. In one embodiment, the device related criteria is also referred to as location constraint criteria information.

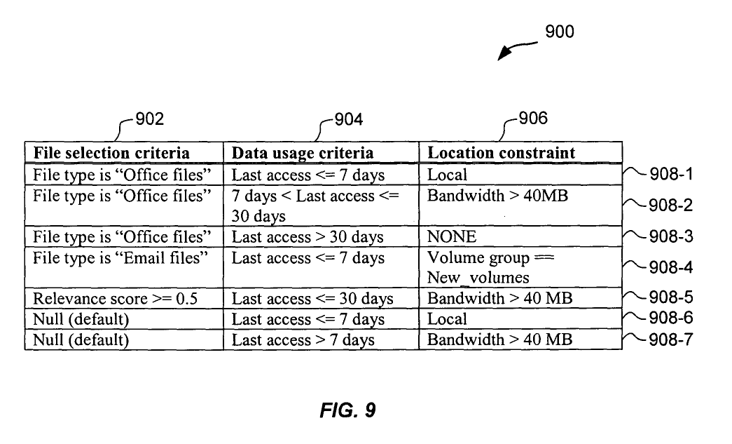

FIG. 9 depicts examples of placement rules according to an embodiment of the present invention. In FIG. 9, each row 908 of table 900 specifies a placement rule. Column 902 of table 900 identifies the file selection criteria information for each rule, column 904 of table 900 identifies the data usage criteria information for each placement rule, and column 906 of table 900 identifies the location constraint criteria information for each rule.

The “file selection criteria information” specifies information identifying conditions related to files. According to an embodiment of the present invention, the selection criteria information for a placement rules specifies one or more clauses (or conditions) related to an attribute of a file such as file type, relevance score of file, file owner, etc. Each clause may be expressed as an absolute value (e.g., File type is “Office files”) or as an inequality (e.g., Relevance score of file>=0.5). Multiple clauses may be connected by Boolean connectors (e.g., File type is “Email files” AND File owner is “John Doe”) to form a Boolean expression. The file selection criteria information may also be left empty (i.e., not configured or set to NULL value), e.g., file selection criteria for placement rules 908-6 and 908-7 depicted in FIG. 9. According to an embodiment of the present invention, the file selection criteria information defaults to a NULL value. An empty or NULL file selection criterion is valid and indicates that all files are selected or are eligible for the placement rule.

The “data usage criteria information” specifies criteria related to file access information associated with a file. For example, for a particular placement rule, this information may specify condition related to when the file was last accessed, created, last modified, and the like. The criteria may be specified using one or more clauses or conditions connected using Boolean connectors. The data usage criteria clauses may be specified as equality conditions or inequality conditions. For example, “file last accessed between 7 days to 30 days ago” (corresponding to placement rule 908-2 depicted in FIG. 9). These criteria may be set by an administrator.

The “location constraint information” for a particular placement rule specifies one or more constraints associated with storing information on a storage unit based upon the particular placement rule. Location constraint information generally specifies parameters associated with a storage unit that need to be satisfied for storing information on the storage unit. The location constraint information may be left empty or may be set to NULL to indicate that no constraints are applicable for the placement rule. For example, no constraints have been specified for placement rule 908-3 depicted in FIG. 9.

According to an embodiment of the present invention, the constraint information may be set to LOCAL (e.g., location constraint information for placement rules 908-1 and 908-6). This indicates that the file is to be stored on a local storage unit that is local to the device used to create the file and is not to be moved or migrated to another storage unit. According to an embodiment of the present invention, a placement rule is not eligible for selection if the constraint information is set to LOCAL, and a DVS of 0 (zero) is assigned for that specific placement rule. A specific storage unit group, or a specific device may be specified in the location constraint information for storing the data file. A minimum bandwidth requirement (e.g., Bandwidth>=10 MB/s) may be specified indicating that the data can only be stored on a storage unit satisfying the constraint. Various other constraints or requirements may also be specified (e.g., constraints related to file size, availability, etc.). The constraints specified by the location constraint information are generally hard constraints implying that a file cannot be stored on a storage unit that does not satisfy the location constraints.

As stated above, a numerical score (referred to as the Data Value Score or DVS) can be generated for a file for each placement rule. For each placement rule, the DVS generated for the file and the placement rule indicates the level of suitability or applicability of the placement rule for that file. The value of the DVS calculated for a particular file using a particular placement rule is based upon the characteristics of the particular file. For example, according to an embodiment of the present invention, for a particular file, higher scores are generated for placement rules that are deemed more suitable or relevant to the particular file.

Several different techniques may be used for generating a DVS for a file using a placement rule. According to one embodiment, the DVS for a file using a placement rule is a simple product of a “file_selection_score” and a “data_usage_score”,

i.e., DVS=file_selection_score* data-usage_score

In the above equation, the file_selection_score and the data-usage_score are equally weighed in the calculation of DVS. However, in alternative embodiments, differing weights may be allocated to the file_selection_score and the data_usage_score to emphasize or deemphasize their effect. According to an embodiment of the present invention, the value of DVS for a file using a placement rule is in the range between 0 and 1 (both inclusive).

According to an embodiment of the present invention, the file_selection_score (also referred to as the “data characteristics score”) for a placement rule is calculated based upon the file selection criteria information of the placement rule and the data_usage_score for the placement rule is calculated based upon the data usage criteria information specified for the placement rule.

As described above, the file selection criteria information and the data usage criteria information specified for the placement rule may comprise one or more clauses or conditions involving one or more parameters connected by Boolean connectors (see FIG. 9). Accordingly, calculation of the file_selection_score involves calculating numerical values for the individual clauses that make up the file selection criteria information for the placement rule and then combining the individual clause scores to calculate the file_selection_score for the placement rule. Likewise, calculation of the data_usage_score involves calculating numerical values for the individual clauses specified for the data usage criteria information for the placement rule and then combining the individual clause scores to calculate the data_usage_score for the placement rule.

According to an embodiment of the present invention, the following rules are used to combine scores generated for the individual clauses to calculate a file_selection_score or data_usage_score:

Rule 1: For an N-way AND operation (i.e., for N clauses connected by an AND connector), the resultant value is the sum of all the individual values calculated for the individual clauses divided by N.

Rule 2: For an N-way OR operation (i.e., for N clauses connected by an OR connector), the resultant value is the largest value calculated for the N clauses.

Rule 3: According to an embodiment of the present invention, the file_selection_score and the data_usage-score are between 0 and 1 (both inclusive).

According to an embodiment of the present invention, the value for each individual clause specified in the file selection criteria is calculated using the following guidelines:

(a) If a NULL (or empty) value is specified in the file selection criteria information then the NULL or empty value gets a score of 1. For example, the file_selection_score for placement rule 908-7 depicted in FIG. 9 is set to 1.

(b) For file type and ownership parameter evaluations, a score of 1 is assigned if the parameter criteria are met, else a score of 0 is assigned. For example, for placement rule 908-4 depicted in FIG. 9, if the file for which the DVS is calculated is of type “Email Files”, then a score of 1 is assigned for the clause. The file_selection_score for placement rule 308-4 is also set to 1 since it comprises only one clause. However, if the file is not an email file, then a score of 0 is assigned for the clause and accordingly the file_selection_score is also set to 0.

(c) If a clause involves an equality test of the “relevance score” (a relevance score may be assigned for a file by an administrator), the score for the clause is calculated using the following equations:

RelScore_{Data}=Relevance score of the file

RelScore_{Rule}=Relevance score specified in the file selection criteria information

Delta=abs(RelScore_{Data}−RelScore_{Rule})

Score=1−(Delta/RelScore_{Rule})

The Score is reset to 0 if it is negative.

(d) If the clause involves an inequality test (e.g., using >, >=, < or <=) related to the “relevance score” (e.g., rule 908-5 in FIG. 9), the score for the clause is calculated using the following equations:

The Score is set to 1 if the parameter inequality is satisfied.

RelScore_{Data}=Relevance score of the data file

RelScore_{Rule}=Relevance score specified in the file selection criteria information

Delta=abs(RelScore_{Data}−RelScoreRule)

Score=1−(Delta/RelScore_{Rule})

The Score is reset to 0 if it is negative.

Once score for the individual clauses have been calculated, the file_selection_score is then calculated based on the individual scores for the clauses in the file selection criteria information using Rules 1, 2, and 3, as described above. The file_selection_score represents the degree of matching (or suitability) between the file selection criteria information for a particular placement rule and the file for which the score is calculated. It should be evident that various other techniques may also be used to calculate the file_selection_score in alternative embodiments of the present invention.

According to an embodiment of the present invention, the score for each clause specified in the data usage criteria information for a placement rule is scored using the following guidelines:

The score for the clause is set to 1 if the parameter condition of the clause is met.

Date_{Data}=Relevant date information for the data file.

Date_{Rule}=Relevant date information in the rule.

Delta=abs(Date_{Data}−Date_{Rule})

Score=1−(Delta/Date_{Rule})

The Score is reset to 0 if it is negative.

If a date range is specified in the clause (e.g., last 7 days), the date range is converted back to the absolute date before the evaluation is made. The data₁₃ usage_score is then calculated based upon scores for the individual clauses specified in the file selection criteria information using Rules 1, 2, and 3, as described above.

It should be evident that various other techniques may also be used to calculate the data_usage_score in alternative embodiments of the present invention. The data_usage_score represents the degree of matching (or suitability) between the data usage criteria information for a particular placement rule and the file for which the score is calculated.

The DVS is then calculated based upon the file_selection_score and data_usage_score. The DVS for a placement rule thus quantifies the degree of matching (or suitability) between the conditions specified in the file selection criteria information and the data usage criteria information for the placement rule and the characteristics of the file for which the score is calculated. According to an embodiment of the present invention, higher scores are generated for placement rules that are deemed more suitable (or are more relevant) for the file.

Several different techniques may be used for ranking the placement rules for a file. The rules are initially ranked based upon DVSs calculated for the placement rules. According to an embodiment of the present invention, if two or more placement rules have the same DVS value, then the following tie-breaking rules may be used:

(a) The placement rules are ranked based upon priorities assigned to the placement rules by a user (e.g., system administrator) of the storage environment.

(b) If the priorities are not set or are equal, then the total number of top level AND operations (i.e., number of clauses connected using AND connectors) used in calculating the file_selection_score and the data_usage_score for a placement rule are used as a tie-breaker. A particular placement rule having a greater number of AND operations that are used in calculating file_selection_score and data_usage_score for the particular rule is ranked higher than another rule having a lesser number of AND operations. The rationale here is that a more specific configuration (indicated by a higher number of clauses connected using AND operations) of the file selection criteria and the data usage criteria is assumed to carry more weight than a more general specification.

(c) If neither (a) nor (b) are able to break the tie between placement rules, some other criteria may be used to break the tie. For example, according to an embodiment of the present invention, the order in which the placement rules are encountered may be used to break the tie. In this embodiment, a placement rule that is encountered earlier is ranked higher than a subsequent placement rule. Various other criteria may also be used to break ties. It should be evident that various other techniques may also be used to rank the placement rules in alternative embodiments of the present invention.

All files that meet all the selection criteria for movement are assigned a DVS of 1, as calculated from the above steps. According to an embodiment of the present invention, in order to break ties, the files are then ranked again by recalculating the DVS using another equation. In one embodiment, the new DVS score equation is defined as:

DVS=file_size/last_access_time

where:

file_size is the size of the file; and

last_access_time is the last time that the file was accessed.

It should be noted that this DVS calculation ranks the files based on their impacts to the overall system when they are moved from the source volume, with a higher score representing a lower impact. In this embodiment, moving a larger file is more effective to balance capacity utilization and moving a file that has not been accessed recently reduces the chances that the file will be recalled. It should be evident that various other techniques may also be used to rank files that have a DVS of 1 in alternative embodiments of the present invention.

As previously stated, placement rules are also used to calculate SVSs for storage units in order to identify a target storage unit. According to an embodiment of the present invention, a SVS for a storage unit is calculated using the following steps:

STEP 1: A “Bandwidth_factor” variable is set to zero (0) if the bandwidth supported by the storage unit for which the score is calculated is less than the bandwidth requirement, if any, specified in the location constraints criteria specified for the placement rule for which the score is calculated. For example, the location constraint criteria for placement rule 908-2 depicted in FIG. 9 specifies that the bandwidth of the storage unit should be greater than 40 MB. Accordingly, if the bandwidth supported by the storage unit is less than 40 MB, then the “Bandwidth_factor” variable is set to 0.

Otherwise, the value of “Bandwidth_factor” is set as follows:

Bandwidth_factor=((Bandwidth supported by the storage unit)−(Bandwidth required by the location constraint of the selected placement rule))+K

where K is set to some constant integer. According to an embodiment of the present invention, K is set to 1. Accordingly, the value of Bandwidth_factor is set to a non-negative value.

STEP 2: SVS is calculated as follows:

SVS=Bandwidth_factor*(desired_threshold_%−current_usage_%)/cost

As described above, the desired_threshold_% for a storage device is usually set by a system administrator. The current_usage_% value is monitored by embodiments of the present invention. The “cost” value may be set by the system administrator.

It should be understood that the formula for calculating SVS shown above is representative of one embodiment of the present invention and is not meant to reduce the scope of the present invention. Various other factors may be used for calculating the SVS in alternative embodiments of the present invention. For example, the availability of a storage unit may also be used to determine the SVS for the device. According to an embodiment of the present invention, availability of a storage unit indicates the amount of time that the storage unit is available during those time periods when it is expected to be available. Availability may be measured as a percentage of an elapsed year in certain embodiments. For example, 99.95% availability equates to 4.38 hours of downtime in a year (0.0005*365*24=4.38) for a storage unit that is expected to be available all the time. According to an embodiment of the present invention, the value of SVS for a storage unit is directly proportional to the availability of the storage unit.

STEP 3: Various adjustments may be made to the SVS calculated according to the above steps. For example, in some storage environments, the administrator may want to group “similar” files together in one storage unit. In other environments, the administrator may want to distribute files among different storage units. The SVS may be adjusted to accommodate the policy adopted by the administrator. Performance characteristics associated with a network that is used to transfer data from the storage devices may also be used to adjust the SVSs for the storage units. For example, the access time (i.e., the time required to provide data stored on a storage unit to a user) of a storage unit may be used to adjust the SVS for the storage unit. The throughput of a storage unit may also be used to adjust the SVS value for the storage unit. Accordingly, parameters such as the location of the storage unit, location of the data source, and other network related parameters might also be used to generate SVSs. According to an embodiment of the present invention, the SVS value is calculated such that it is directly proportional to the desirability of the storage unit for storing the file.

According to an embodiment of the present invention, a higher SVS value represents a more desirable storage unit for storing a file. As indicated, the SVS value is directly proportional to the available capacity percentage. Accordingly, a storage unit with higher available capacity is more desirable for storing a file. The SVS value is inversely proportional to the cost of storing data on the storage unit. Accordingly, a storage unit with lower storage costs is more desirable for storing a file. The SVS value is directly proportional to the bandwidth requirement. Accordingly, a storage unit supporting a higher bandwidth is more desirable for storing the file. SVS is zero if the bandwidth requirements are not satisfied. Accordingly, the SVS formula for a particular storage unit combines the various storage unit characteristics to generate a score that represents the degree of desirability of storing data on the particular storage unit.

According to the above formula, SVS is zero (0) if the value of Bandwidth_factor is zero. As described above, Bandwidth_factor is set to zero if the bandwidth supported by the storage unit is less than the bandwidth requirement, if any, specified in the location constraints criteria information specified for the selected placement rule. Accordingly, if the value of SVS for a particular storage unit is zero (0) it implies that bandwidth supported by the storage unit is less than the bandwidth required by the placement rule, or the storage unit is already at or exceeds the desired capacity threshold. Alternatively, SVS is zero (0) if the desired_threshold_% is equal to the current_usage_%.

If the SVS for a storage unit is positive, it indicates that the storage unit meets both the bandwidth requirements (i.e., Bandwidth_factor is non zero) and also has enough capacity for storing the file (i.e., desired_threshold_% is greater than the current_usage_%). The higher the SVS value, the more suitable (or desirable) the storage unit is for storing a file. For storage units with positive SVSs, the storage unit with the highest positive RSVS is the most desirable candidate for storing the file. The SVS for a particular storage unit thus provides a measure for determining the degree of desirability for storing data on the particular storage unit relative to other storage unit for a particular placement rule being processed. Accordingly, the SVS is also referred to as the relative storage value score (RSVS). The SVS in conjunction with the placement rules and their rankings is used to determine an optimal storage location for storing the data to be moved from the source storage unit.

The SVS for a particular storage unit may be negative if the storage unit meets the bandwidth requirements but the storage unit's usage is above the intended threshold (i.e., current_usage_% is greater than the desired_threshold_%). The relative magnitude of the negative value indicates the degree of over-capacity of the storage unit. Among storage units with negative SVSs, the closer the SVS is to zero (0) and the storage unit has capacity for storing the data, the more desirable the storage unit is for storing the data file. For example, the over-capacity of a storage unit having SVS of 0.9 is more than the over-capacity of a second storage unit having RSVS −0.1. Accordingly, the second storage unit is a more attractive candidate for storing the data file as compared to the first storage unit. Accordingly, the SVS, even if negative, can be used in ranking the storage units relative to each other for purposes of storing data.

The SVS for a particular storage unit thus serves as a measure for determining the degree of desirability or suitability of the particular storage unit for storing data relative to other storage devices. A storage unit having a positive SVS value is a better candidate for storing the data file than a storage unit with a negative SVS value, since a positive value indicates that the storage unit meets the bandwidth requirements for the data file and also possesses sufficient capacity for storing the data file. Among storage units with positive SVS values, a storage unit with a higher positive SVS is a more desirable candidate for storing the data file than a storage unit with a lower SVS value, i.e., the storage unit having the highest positive SVS value is the most desirable storage unit for storing the data file.

If a storage unit with a positive SVS value is not available, then storage units with negative SVS values are more desirable than devices with an SVS value of zero (0). The rationale here is that it is better to select a storage unit that satisfies the bandwidth requirements (even though the storage unit is over capacity) than a storage unit that does not meet the bandwidth requirements (i.e., has a SVS of zero). Among storage units with negative SVS values, a storage unit with a higher SVS value (i.e., SVS closer to 0) is a more desirable candidate for storing the data file than a storage unit with a lesser SVS value. Accordingly, among storage units with negative SVS values, the storage unit with the highest SVS value (i.e., SVS closest to 0) is the most desirable candidate for storing the data file.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps. It should be understood that the equations described above are only illustrative of an embodiment of the present invention and can vary in alternative embodiments of the present invention.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A computer-implemented method of managing a storage environment comprising storage units, the method comprising:
detecting a condition indicating that capacity utilization balancing is to be performed for a plurality of storage units;
identifying a first storage unit from the plurality of storage units from which data is to be moved;
identifying a file stored on the first storage unit to be moved;
identifying a storage unit from the plurality of storage units for storing the file;
moving the file from the first storage unit to the storage unit identified for storing the file; and
repeating, the identifying a file stored on the first storage unit to be moved, the identifying a storage unit from the plurality of storage units for storing the file, and the moving the file from the first storage unit to the storage unit identified for storing the file, until the condition is determined to be resolved.

2. The method of claim 1 wherein:
detecting the condition comprises detecting a condition that indicates that used storage capacity for at least one storage unit from the plurality of storage units has exceeded a first threshold value; and
the condition is determined to be resolved when the used storage capacity of the at least one storage capacity for the storage unit falls below the first threshold value.

3. The method of claim 2 wherein identifying the first storage unit comprises:
identifying the at least one storage unit whose used storage capacity has exceeded the first threshold value as the first storage unit.

4. The method of claim 1 wherein:
detecting the condition comprises detecting that a difference in used capacity of a least full storage unit and the most full storage unit in the plurality of storage units has exceeded a second threshold value; and
the condition is determined to be resolved when the difference is within the second threshold value.

5. The method of claim 4 wherein identifying the first storage unit comprises:
identifying the most full storage unit as the first storage unit.

6. The method of claim 1 further comprising:
determining a storage unit from the plurality of storage units that is least full;
determining a storage unit from the plurality of storage units that is most full;
determining a difference in used capacity between the least full storage unit and the most full storage unit; and
performing, the identifying a first storage unit from the plurality of storage units from which data is to be moved, the identifying a file stored on the first storage unit to be moved, the identifying a storage unit from the plurality of storage units for storing the file, the moving the file from the first storage unit to the storage unit identified for storing the file, and the repeating, only if the difference exceeds a pre-configured threshold value.

7. The method of claim 1 wherein identifying a file stored on the first storage unit to be moved comprises:
generating a score for each file included in a plurality of files stored on the first storage unit; and
selecting a file, from the files stored on the first storage unit, a file with the highest score as the file to be moved.

8. The method of claim 1 wherein identifying a storage unit from the plurality of storage units for storing the file comprises:
generating a score for the storage units in the plurality of storage units; and
selecting a storage unit from the plurality of storage units with the highest score as the storage unit for storing the file.

9. The method of claim 1 wherein repeating comprises:
determining a storage unit from the plurality of storage units that is least full;
determining a storage unit from the plurality of storage units that is most full;
determining a difference in used capacity between the least full storage unit and the most full storage unit; and
repeating, the identifying a file stored on the first storage unit to be moved, the identifying a storage unit from the plurality of storage units for storing the file, and the moving the file from the first storage unit to the storage unit identified for storing the file, only if the difference exceeds a pre-configured threshold value.

10. The method of claim 1 wherein the plurality of storage units comprises at least one storage unit assigned to a first server and at least another storage unit assigned to a second server distinct from the first server.

11. The method of claim 1 wherein an original file stored on the first storage unit is not moved until all migrated files stored on the first storage unit have been moved.

12. In a storage environment comprising a plurality of storage units assigned to one or more servers, a computer-implemented method of performing capacity utilization balancing, the method comprising:
monitoring a first group of storage units from the plurality of storage units;
receiving a first signal indicative of a condition;
responsive to the first signal, determining a first storage unit from the first group of storage units from which data is to be moved; and
moving data from the first storage unit to one or more other storage units in the first group of storage units until the condition is resolved.

13. The method of claim 12 wherein:
the first signal indicates that used storage capacity for a storage unit from the first group of storage units has exceeded a first threshold; and
determining the first storage unit comprises identifying the storage unit whose used storage capacity has exceeded the first threshold as the first storage unit.

14. The method of claim 12 wherein moving data from the first storage unit to one or more other storage units in the first group of storage units comprises:
identifying a file stored on the first storage unit to be moved;
identifying a storage unit from the first group of storage units for storing the file;
moving the file from the first storage unit to the storage unit identified for storing the file; and
repeating, the identifying a file, identifying a storage unit, and the moving the file, until the condition is determined to be resolved.

15. The method of claim 14 wherein identifying a file stored on the first storage unit to be moved comprises:
generating a score for each file included in a plurality of files stored on the first storage unit; and
selecting a file, from the files stored on the first storage unit, with the highest score as the file to be moved.

16. The method of claim 14 wherein identifying a storage unit from the first group of storage units for storing the file comprises:
generating a score for the storage units in the first group of storage units; and
selecting a storage unit from the first group of storage units with the highest score as the storage unit for storing the file.

17. The method of claim 12 wherein moving data from the first storage unit to one or more other storage units in the first group of storage units comprises:
moving a first file stored on the first storage unit to a first target storage unit included in the first group of storage units; and
moving a second file stored on the first storage unit to a second target storage unit included in the first group of storage units, wherein the second target storage unit is distinct from the first target storage unit.

18. The method of claim 12 further comprising:
determining a storage unit from the first group of storage units that is least full;
determining a storage unit from the first group of storage units that is most full;
determining a difference in used capacity between the least full storage unit and the most full storage unit; and
performing the determining the first storage unit step and the moving step only if the difference exceeds a pre-configured threshold value.

19. The method of claim 12 further comprising:
receiving information indicative of storage units from the plurality of storage units to be included in the first group of storage units.

20. The method of claim 12 wherein the first group of storage units comprises at least one storage unit assigned to a first server and at least another storage unit assigned to a second server distinct from the first server.

21. The method of claim 12 wherein original data stored on the first storage unit is not moved until all migrated data stored on the first storage unit has been moved.

22. A computer program product stored on a computer-readable medium for balancing capacity utilization in a storage environment comprising storage units, the computer program product comprising instructions for:
detecting a condition indicating that capacity utilization balancing is to be performed for a plurality of storage units;
identifying a first storage unit from the plurality of storage units from which data is to be moved;
identifying a file stored on the first storage unit to be moved;
identifying a storage unit from the plurality of storage units for storing the file;
moving the file from the first storage unit to the storage unit identified for storing the file; and
repeating, the identifying a file stored on the first storage unit to be moved, the identifying a storage unit from the plurality of storage units for storing the file, and the moving the file from the first storage unit to the storage unit identified for storing the file, until the condition is determined to be resolved.

23. The computer program product of claim 22 wherein:
the instructions for detecting the condition comprise instructions for detecting a condition that indicates that used storage capacity for at least one storage unit from the plurality of storage units has exceeded a first threshold value; and
the condition is determined to be resolved when the used storage capacity of the at least one storage capacity for the storage unit falls below the first threshold value.

24. The computer program product of claim 23 wherein the instructions for identifying the first storage unit comprise:
instructions for identifying the at least one storage unit whose used storage capacity has exceeded the first threshold value as the first storage unit.

25. The computer program product of claim 22 wherein:
the instructions for detecting the condition comprise instructions for detecting that a difference in used capacity of a least full storage unit and the most full storage unit in the plurality of storage units has exceeded a second threshold value; and
the condition is determined to be resolved when the difference is within the second threshold value.

26. The computer program product of claim 25 wherein the instructions for identifying the first storage unit comprise instructions for identifying the most full storage unit as the first storage unit.

27. The computer program product of claim 22 further comprising instructions for:
determining a storage unit from the plurality of storage units that is least full;
determining a storage unit from the plurality of storage units that is most full;
determining a difference in used capacity between the least full storage unit and the most full storage unit; and
performing, the identifying a first storage unit from the plurality of storage units from which data is to be moved, the identifying a file stored on the first storage unit to be moved, the identifying a storage unit from the plurality of storage units for storing the file, the moving the file from the first storage unit to the storage unit identified for storing the file, and the repeating, only if the difference exceeds a pre-configured threshold value.

28. The computer program product of claim 22 wherein the instructions for identifying a file stored on the first storage unit to be moved comprise instructions for:
generating a score for each file included in a plurality of files stored on the first storage unit; and
selecting a file, from the files stored on the first storage unit, a file with the highest score as the file to be moved.

29. The computer program product of claim 22 wherein the instructions for identifying a storage unit from the plurality of storage units for storing the file comprise instructions for:
generating a score for the storage units in the plurality of storage units; and
selecting a storage unit from the plurality of storage units with the highest score as the storage unit for storing the file.

30. The computer program product of claim 22 wherein the instructions for repeating comprise:
determining a storage unit from the plurality of storage units that is least full;
determining a storage unit from the plurality of storage units that is most full;
determining a difference in used capacity between the least full storage unit and the most full storage unit; and
repeating, the identifying a file stored on the first storage unit to be moved, the identifying a storage unit from the plurality of storage units for storing the file, and the moving the file from the first storage unit to the storage unit identified for storing the file, only if the difference exceeds a pre-configured threshold value.

31. The computer program product of claim 22 wherein the plurality of storage units comprises at least one storage unit assigned to a first server and at least another storage unit assigned to a second server distinct from the first server.

32. The computer program product of claim 22 wherein an original file stored on the first storage unit is not moved until all migrated files stored on the first storage unit have been moved.

33. A computer program product stored on a computer-readable medium comprising code for performing capacity utilization balancing in a storage environment comprising a plurality of storage units assigned to one or more servers, the computer program product comprising code for:
monitoring a first group of storage units from the plurality of storage units;
receiving a first signal indicative of a condition;
determining, responsive to the first signal, a first storage unit from the first group of storage units from which data is to be moved; and
moving data from the first storage unit to one or more other storage units in the first group of storage units until the condition is resolved.

34. The computer program product of claim 33 wherein:
the first signal indicates that used storage capacity for a storage unit from the first group of storage units has exceeded a first threshold; and
the code for determining the first storage unit comprises code for identifying the storage unit whose used storage capacity has exceeded the first threshold as the first storage unit.

35. The computer program product of claim 33 wherein the code for moving data from the first storage unit to one or more other storage units in the first group of storage units comprises code for:
identifying a file stored on the first storage unit to be moved;
identifying a storage unit from the first group of storage units for storing the file;
moving the file from the first storage unit to the storage unit identified for storing the file; and
repeating, the identifying a file, identifying a storage unit, and the moving the file, until the condition is determined to be resolved.

36. The computer program product of claim 35 wherein the code for identifying a file stored on the first storage unit to be moved comprises:
code for generating a score for each file included in a plurality of files stored on the first storage unit; and
code for selecting a file, from the files stored on the first storage unit, with the highest score as the file to be moved.

37. The computer program product of claim 35 wherein the code for identifying a storage unit from the first group of storage units for storing the file comprises:
code for generating a score for the storage units in the first group of storage units; and
code for selecting a storage unit from the first group of storage units with the highest score as the storage unit for storing the file.

38. The computer program product of claim 33 wherein the code for moving data from the first storage unit to one or more other storage units in the first group of storage units comprises:
code for moving a first file stored on the first storage unit to a first target storage unit included in the first group of storage units; and
code for moving a second file stored on the first storage unit to a second target storage unit included in the first group of storage units, wherein the second target storage unit is distinct from the first target storage unit.

39. The computer program product of claim 33 further comprising:
code for determining a storage unit from the first group of storage units that is least full;
code for determining a storage unit from the first group of storage units that is most full;
code for determining a difference in used capacity between the least full storage unit and the most full storage unit; and
code for performing the determining the first storage unit step and the moving step only if the difference exceeds a pre-configured threshold value.

40. The computer program product of claim 33 further comprising:
code for receiving information indicative of storage units from the plurality of storage units to be included in the first group of storage units.

41. The computer program product of claim 33 wherein the first group of storage units comprises at least one storage unit assigned to a first server and at least another storage unit assigned to a second server distinct from the first server.

42. The computer program product of claim 33 wherein original data stored on the first storage unit is not moved until all migrated data stored on the first storage unit has been moved.

43. In a storage environment comprising storage units, a system comprising:
at least one processor; and
a memory operatively coupled to the processor, the memory storing program instructions that when executed by the processor, cause the processor to:
detect a condition indicating that capacity utilization balancing is to be performed for a plurality of storage units,
identify a first storage unit from the plurality of storage units from which data is to be moved,
identify a file stored on the first storage unit to be moved,
identify a storage unit from the plurality of storage units for storing the file,
move the file from the first storage unit to the storage unit identified for storing the file, and
repeat, the identification of a file stored on the first storage unit to be moved, the identification of a storage unit from the plurality of storage units for storing the file, and the move of the file from the first storage unit to the storage unit identified for storing the file, until the condition is determined to be resolved.

44. The system of claim 43 wherein the program instructions when executed by the processor, cause the processor to detect a condition that indicates that used storage capacity for at least one storage unit from the plurality of storage units has exceeded a first threshold value, and the condition is determined to be resolved when the used storage capacity of the at least one storage capacity for the storage unit falls below the first threshold value.

45. The system of claim 44 wherein the program instructions when executed by the processor, cause the processor to identify the at least one storage unit whose used storage capacity has exceeded the first threshold value as the first storage unit.

46. The system of claim 43 wherein the program instructions when executed by the processor, cause the processor to detect the condition comprises detecting that a difference in used capacity of a least full storage unit and the most full storage unit in the plurality of storage units has exceeded a second threshold value, and the condition is determined to be resolved when the difference is within the second threshold value.

47. The system of claim 46 wherein the program instructions when executed by the processor, cause the processor to identify the most full storage unit as the first storage unit.

48. The system of claim 43 wherein the program instructions when executed by the processor, cause the processor to:
determine a storage unit from the plurality of storage units that is least full,
determine a storage unit from the plurality of storage units that is most full,
determine a difference in used capacity between the least full storage unit and the most full storage unit, and
perform, the identification of a first storage unit from the plurality of storage units from which data is to be moved, the identification of a file stored on the first storage unit to be moved, the identification of a storage unit from the plurality of storage units for storing the file, the move of the file from the first storage unit to the storage unit identified for storing the file, and the repeating, only if the difference exceeds a pre-configured threshold value.

49. The system of claim 43 wherein the program instructions when executed by the processor, cause the processor to:
generate a score for each file included in a plurality of files stored on the first storage unit, and
select a file, from the files stored on the first storage unit, a file with the highest score as the file to be moved.

50. The system of claim 43 wherein the program instructions when executed by the processor, cause the processor to:
generate a score for the storage units in the plurality of storage units, and select a storage unit from the plurality of storage units with the highest score as the storage unit for storing the file.

51. The system of claim 43 wherein the program instructions when executed by the processor, cause the processor to:
determine a storage unit from the plurality of storage units that is least full,
determine a storage unit from the plurality of storage units that is most full,
determine a difference in used capacity between the least full storage unit and the most full storage unit, and
repeat, the identification of a file stored on the first storage unit to be moved, the identification of a storage unit from the plurality of storage units for storing the file, and the move of the file from the first storage unit to the storage unit identified for storing the file, only if the difference exceeds a pre-configured threshold value.

52. The system of claim 43 wherein the plurality of storage units comprises at least one storage unit assigned to a first server and at least another storage unit assigned to a second server distinct from the first server.

53. The system of claim 43 wherein an original file stored on the first storage unit is not moved until all migrated files stored on the first storage unit have been moved.

54. In a storage environment comprising a plurality of storage units assigned to one or more servers, a system for performing capacity utilization balancing, the system comprising:
at least one processor; and
a memory operatively coupled to the processor, the memory storing program instructions that when executed by the processor, cause the processor to:
monitor a first group of storage units from the plurality of storage units,
receive a first signal indicative of a condition,
determine, responsive to the first signal, a first storage unit from the first group of storage units from which data is to be moved, and
move data from the first storage unit to one or more other storage units in the first group of storage units until the condition is resolved.

55. The system of claim 54 wherein:
the first signal indicates that used storage capacity for a storage unit from the first group of storage units has exceeded a first threshold; and
the program instructions when executed by the processor, cause the processor to identify the storage unit whose used storage capacity has exceeded the first threshold as the first storage unit.

56. The system of claim 54 wherein the program instructions when executed by the processor, cause the processor to:
identify a file stored on the first storage unit to be moved,
identify a storage unit from the first group of storage units for storing the file,
move the file from the first storage unit to the storage unit identified for storing the file, and
repeat, the identification of a file, identification of a storage unit, and the move of the file, until the condition is determined to be resolved.

57. The system of claim 56 wherein the program instructions when executed by the processor, cause the processor to:
generate a score for each file included in a plurality of files stored on the first storage unit, and
select a file, from the files stored on the first storage unit, with the highest score as the file to be moved.

58. The system of claim 56 wherein the program instructions when executed by the processor, cause the processor to:
generate a score for the storage units in the first group of storage units, and
select a storage unit from the first group of storage units with the highest score as the storage unit for storing the file.

59. The system of claim 54 wherein the program instructions when executed by the processor, cause the processor to:
move a first file stored on the first storage unit to a first target storage unit included in the first group of storage units, and
move a second file stored on the first storage unit to a second target storage unit included in the first group of storage units, wherein the second target storage unit is distinct from the first target storage unit.

60. The system of claim 54 wherein the program instructions when executed by the processor, cause the processor to:
determine a storage unit from the first group of storage units that is least full,
determine a storage unit from the first group of storage units that is most full,
determine a difference in used capacity between the least full storage unit and the most full storage unit, and
perform the determining the first storage unit step and the moving step only if the difference exceeds a pre-configured threshold value.

61. The system of claim 54 wherein the program instructions when executed by the processor, cause the processor to receive information indicative of storage units from the plurality of storage units to be included in the first group of storage units.

62. The system of claim 54 wherein the first group of storage units comprises at least one storage unit assigned to a first server and at least another storage unit assigned to a second server distinct from the first server.

63. The system of claim 54 wherein original data stored on the first storage unit is not moved until all migrated data stored on the first storage unit has been moved.

64. A system for balancing capacity utilization in a storage environment comprising storage units, the system comprising:
means for detecting a condition indicating that capacity utilization balancing is to be performed for a plurality of storage units;
means for identifying a first storage unit from the plurality of storage units from which data is to be moved;
means for identifying a file stored on the first storage unit to be moved;
means for identifying a storage unit from the plurality of storage units for storing the file;
means for moving the file from the first storage unit to the storage unit identified for storing the file; and
means for repeating, identifying a file stored on the first storage unit to be moved, identifying a storage unit from the plurality of storage units for storing the file, and moving the file from the first storage unit to the storage unit identified for storing the file, until the condition is determined to be resolved.

65. A system for performing capacity utilization balancing in a storage environment comprising a plurality of storage units assigned to one or more servers, the system comprising:
monitoring a first group of storage units from the plurality of storage units;
receiving a first signal indicative of a condition;
determining, responsive to the first signal, a first storage unit from the first group of storage units from which data is to be moved; and
moving data from the first storage unit to one or more other storage units in the first group of storage units until the condition is resolved.
